(19) United States
(12) Patent Application Publication
(10) Pub. No.: US 2003/0052043 A1
(43) Pub. Date: Mar. 20, 2003

(54) Structured catalysts and processes for gas/liquid reactors

(76) Inventors: Achim K. Heibel, Nentershausen (DE); Wei Liu, Painted Post, NY (US); Matthew C. Morse, Campbell, NY (US)

Correspondence Address: CORNING INCORPORATED, SP-TI-3-1, CORNING, NY, 14831

(21) Appl. No.: 10/008,059

(22) Filed: Nov. 13, 2001

Related U.S. Application Data
(63) Continuation-in-part of application No. 09/952,173, filed on Sep. 15, 2001.

(51) Int. Cl. C10G 25/00; B01J 21/04

(52) U.S. Cl. 208/143; 208/300; 208/177; 502/439

(57) ABSTRACT

A channel geometry for monolith and honeycomb catalysts used in two- and three-phase catalytic reactions or gas-liquid mass transfer processes features a desirable channel shape that enhances liquid/structure contacting efficiency and gas/liquid catalytic reaction activity. Gas/liquid catalytic hydrogenation or hydrotreating processes carried with these catalysts use efficient liquid/channel surface contacting and mass transfer of reactants from bulk liquid onto the channel surface to achieve high conversion efficiencies.

This application is a continuation-in-part of application Ser. No. 09/952,173, filed Sep. 15, 2001.

### BACKGROUND OF THE INVENTION

The present invention relates to structured catalysts or packings and, more particularly, to an improved channel geometry for monolithic and honeycomb catalyst structures, and processes using them.

The use of structured catalysts, such as honeycombs that are coated or formed with catalytically active materials, is well known in the art. Most commonly known are the ceramic and metallic honeycombs coated with platinum that are ubiquitously used in automotive pollution control devices.

Many early examples comprised two-phase (vapor-catalyst) chemical processes that featured a mixed vapor stream conveyed through a channeled honeycomb. The honeycomb consisted of a bundle of cylindrical tubes or channels of square or triangular cross-section. Channels with electrically conductive heating layers, and catalysts used in hydrocarbon oxidation or sulfur trioxide production, are illustrated in U.S. Pat. No. 3,507,627.

U.S. Pat. No. 3,167,499 discloses the use of thin catalyst coatings disposed on large-pored, granular supports, or on skeletal, or sponge-like supporting structures, for treating petroleum feedstocks boiling in the gas-oil range. Wire gauze, rod and tube bundles, spirally laid-up corrugated structures, or other high-void-fraction assemblies can be supports for these catalyst coatings.

Adapting metallic or ceramic honeycombs to three-phase (liquid-vapor-catalyst) reactant mixtures for controlling liquid and gas flows and the distribution of liquid and gas phases within their channels has proven difficult. Often, the processing efficiency of such honeycombs has been highly dependent upon the nature of the reaction.

Catalyst honeycombs for controlling liquid flow are shown in published PCT patent application WO 94/09901. In that application, the interiors of the channels are provided with grooves or spaces in which liquid phases present in the reactant stream collect via capillary action. The problems with this scheme, however, are both the high cost of the catalyst design and the uncertainty of the conversion efficiencies.

Commercial interest in monolithic honeycomb catalysts is increasing and some preliminary studies about the effects of channel geometry on hydrodynamic behavior have been reported. However, there is little information about the effect these channel geometries, or channel shapes, have upon the catalytic contacting efficiency. For example, Lebens et al. describe, in “Hydrodynamics of gas-liquid counter-current flow in internally finned monolithic structures”, Chemical Engineering Science, Vol. 52, No. 21/22, pp. 3893-3899, (1997), the use of internal fins to stabilize the counter-current gas/liquid flow in monolith-like structures. Further, Papadias et al. in “Simplified method for effectiveness factor calculations in irregular geometries of washcoat”, Chemical Engineering Science, Vol. 55, pp. 1447-1459 (2000), developed a simplified method of calculating the effectiveness of irregular geometries of catalyst layers upon the washcoated monolith catalyst.

The present invention is based on the discovery that the mass transfer and conversion efficiency of honeycomb structured catalysts for three-phase processes can be improved through the use of catalyst designs wherein liquid concentrations within the channels of the honeycombs are minimized. Contrary to the teachings of the prior art, the present invention eschews triangular, rectangular, or generally acutely angled cross-sections that allow liquid feed stream components to collect in preferred flow paths within the channels. Corners or other discontinuities in the channel walls that could serve to concentrate and channel flowing liquids are avoided.

### SUMMARY OF THE INVENTION

In accordance with the present invention, there is provided an improved honeycomb or monolith catalyst structure that provides for improved mass transfer and conversion efficiency in three-phase catalytic reactions. The improved catalyst structure minimizes liquid concentrations within the channels (cells) of the honeycombs or monoliths by avoiding acute angles in the channel structure.

The characteristic feature if the improved catalyst structure is a channel cross-section free of acute and sharply obtuse interior corner angles. Closed curved channel cross-sections are preferred. Planar wall sections in the channels, if present, are joined by curved wall sections (rounded corners) rather than by angular corners. Thus the general requirement for channel shape in these improved catalysts is that the cross-sectional shape of the honeycomb channels will be free of angled corners and free of wall curvatures having curvature radii below 10% of the average channel diameter. Preferably, the channels will have wall curvature radii above 10% of the average channel diameter, with channels having a circularly shaped cross-section being preferred.

In addition to improved mass transfer and conversion efficiencies as catalyst supports, honeycomb structures incorporating appropriately rounded channel shapes can also be used as gas-liquid contactors for gas-liquid mass transfer processes. Thus these honeycombs offer significant performance advantages as structured packings for a variety of applications wherein high gas-liquid mass transfer efficiencies are required.

### DESCRIPTION OF THE DRAWINGS

A further understanding of the present invention may be obtained by reference to the accompanying drawings, when considered in conjunction with the subsequent detailed description, wherein:

FIGS. 1a and 1b present schematic views of liquid/catalyst surface contacting in monolith channels, one monolith channel having angled corners and the other monolith channel having a substantially circular cross-section providing a smoothly curved wall surface;

FIGS. 2a, 2b, and 2c depict sectional views of honeycomb catalyst structures, wherein FIGS. 2a and 2b show channels with square cross-sections and FIG. 2c illustrates a channel having a circular cross-section;

FIG. 3 shows a graph of olefin hydrogenation activity in Ni/alumina honeycomb catalysts;

FIG. 4 presents a graph depicting hydrogenation activity in honeycomb catalysts having wall thicknesses differing from the catalysts of FIG. 3;

FIGS. 5a-5b present graphs depicting hydrogenation activity in honeycomb catalysts having channel shapes differing from the catalyst of FIG. 3;

FIGS. 6a-6b present graphs depicting the effects of H2/oil ratio on hydrogenation activity in honeycomb catalysts;

FIG. 7 presents a graph illustrating the effect of honeycomb catalyst channel shape on the conversion-temperature profile;

FIG. 8 is a graph plotting the effect that the channel shape of a honeycomb catalyst has upon the activity-velocity profile;

FIG. 9 is a graph plotting the specific toluene conversion activity of crushed samples from two different honeycomb catalysts as a function of temperature; and

FIG. 10 graphs the effect that pressure has upon the toluene conversion efficiency of a honeycomb catalyst with a circularly shaped cross-section.

### DETAILED DESCRIPTION

Generally speaking, the present invention teaches a catalyst structure for two- and three-phase catalytic reactions featuring a channel shape that enhances liquid/structure contacting efficiency and gas/liquid catalytic reaction activity. For gas/liquid catalytic reactions inside the catalyst structure, efficient liquid/channel surface contacting and mass transfer of reactants from bulk liquid onto the channel surface have been determined to be critical factors to achieve high conversion efficiency.

For better liquid/catalyst contacting and interfacial mass transfer, minimizing acute or other sharp wall angles inside the monolith channel is mandatory. Thus, channels of circular or other close-curved cross-section, or channels with rounded corners, are preferred. The sizes of the channels is not critical, but average cross-sectional channel diameters in the range of about 0.1 to 10 mm are preferred.

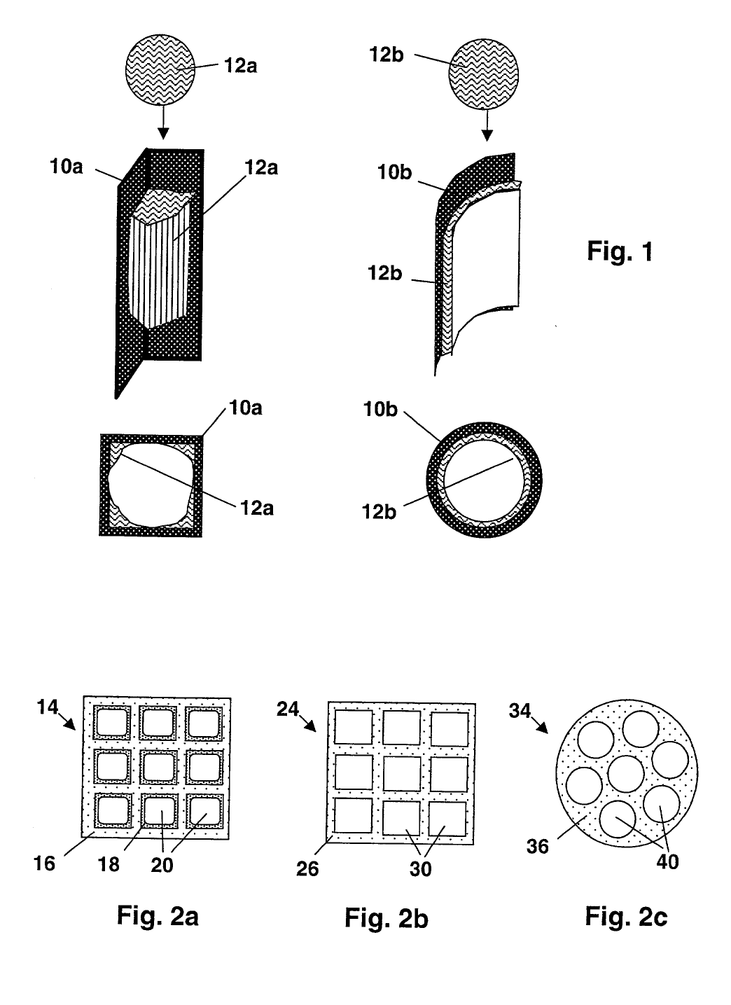

FIGS. 1a and 1b present partial schematic perspective and cross-sectional views, respectively, of a single channel 10a of a prior art structured catalyst of square channel geometry, and a single channel 10b of a catalyst of circular channel cross-section.

When fluid (liquid or gas) e.g., from a droplet of a liquid 12a, passes through a monolith channel having a square cross-section, as shown in FIG. 1a, the fluid 12a tends to be trapped within and adjacent the corners of the channel, due to capillary forces. This fraction of trapped fluid tends to be a dead fluid pocket. As a result, the fraction of the fluid volume that is in actual contact with the catalyst surface is significantly reduced. Furthermore, the non-uniform channel surface does not favor a rapid breakdown of a liquid droplet into a thin film on the catalyst surface. This results in a reduced mass transfer of reactants from bulk liquid onto the catalyst surface.

In contrast to the square channel, the circular channel shown in FIG. 1b provides a uniform catalyst surface, so that the liquid 12b from a droplet can rapidly disperse on the surface as a thin film. This results in a catalyst surface that is fully utilized. Thus, a higher catalytic contacting efficiency, resulting from higher catalyst surface coverage by the liquid and a more rapid liquid/catalyst interfacial mass transfer, is realized by use of the circular channel.

Some of the performance advantages of curved channel walls in honeycomb catalysts provided in accordance with the invention are illustrated in several comparative examples set forth below. Those examples employ a number of honeycomb catalysts of differing substrate geometry and catalyzed surface characteristics, including the honeycomb catalysts set forth in Table 1 below.

Included in Table 1 for each of the various catalysts are the shape or geometry of the honeycomb channels, the cell density or number of channels per unit area of honeycomb cross-section, the thickness of the walls of the channels, and the surface characteristics of the catalyzed channel wall surfaces. Those surface characteristics, which affect catalytic activity in varying degrees depending upon the particular composition of the catalyst employed, include the effective surface area of the material forming the catalyzed wall surfaces, as determined by nitrogen BET analysis, and the pore volume and average pore diameter of that material.

TABLE 1
Catalyst Samples

| | | | | Wall | BET | | |
|---|---|---|---|---|---|---|---|
| | Channel | Cell | Channel | Thick- | surface | Pore | Pore |
| Catalyst | cross- | density | Diameter | ness | area | volume | Diameter |
| ID | section | (cpsi) | (mm) | (mm) | (m2/g) | (cc/g) | (A) |
| A | rounded | 400 | 1 | 0.18 | 38.1 | 0.11 | 95.8 |
| | corner | | | | | | |
| | (FIG. 2a) | | | | | | |
| B | square | 400 | 1 | 0.18 | 214 | 0.68 | 95.7 |
| | (FIG. 2b) | | | | | | |
| C | square | 200 | 1 | 0.71 | 212 | | |
| | (FIG. 2b) | | | | | | |
| D | square | 100 | 2 | 0.64 | 187 | 0.47 | 65.4 |
| | (FIG. 2b) | | | | | | |
| E | circular | ˜100 | 2 | 1.00 | 175 | 0.51 | 77.7 |
| | (FIG. 2C) | | | | | | |

### EXAMPLE I

### Nickel/Gamma-Alumina Catalyst Preparation

A catalyst having the geometry and cell wall characteristics of Catalyst A from Table 1 above, including a rounded-corner channel shape such as illustrated for catalyst 14 in FIG. 2a of the drawing (although that Figure is not shown in true proportion or to scale), is first prepared. To prepare this catalyst, a square-channeled cordierite honeycomb substrate 16 supporting a gamma alumina washcoat 18 on the walls of all channels 20 is impregnated with a 2M nickel nitrate solution. The cordierite honeycomb has a cell density of 400 cells per square inch (cpsi) of honeycomb cross-section. The square corners of the channels of the cordierite substrate become rounded after application of the gamma alumina washcoat, as illustrated in FIG. 2a. After washcoating, the nominal channel diameter of the honeycomb catalyst is about 1 mm and the curvature radii of the rounded corner sections of the channel cross-sections is in excess of 0.1 mm.

The catalyst preparation procedure comprises fully immersing the washcoated honeycomb in an aqueous 2M nickel nitrate solution, removing the honeycomb from the solution and clearing the channels with compressed air, drying the honeycomb at 100° C. for 16 hours, and calcining the dried honeycomb in air at 400° C. for 2 hours.

Additional honeycomb catalyst samples, corresponding to Catalysts B, C, D and E as reported in Table 1 above, are impregnated with a nickel catalyst substantially following the procedure employed above to prepare Catalyst A. However, in each case a honeycomb substrate composed entirely of gamma-alumina is used in place of the alumina-washcoated cordierite honeycomb of Catalyst A.

Referring to FIGS. 2b and 2c of the drawings, prepared catalysts B, C, and D all had substantially the configuration of catalyst 24 in FIG. 2b, comprising a plurality of square channels 30 within an alumina honeycomb 26. Catalyst E had substantially the configuration of catalyst 34 in FIG. 2c, comprising a plurality of circular channels 40 in an alumina honeycomb 36.

As reported in Table 1 above, Catalysts A and B have similar channel dimensions, but differ in channel shape. Catalysts B and C have similar channel dimensions, but different wall thickness, while Catalysts D and E have similar channel dimensions but different channel shapes. Thus differences in the performance of these catalysts will stem in large part from differences in channel size and shape, rather from differences in catalyst composition.

### EXAMPLE II

### Channel Shape Effects—Olefin Hydrogenation

Catalysts A and B above are evaluated for efficiency in two three-phase olefin hydrogenation reactions of commercial interest. The two reactions used for the evaluations are the following:

Styrene+H2→Ethylbenzene

1-Octene+H2→N-Octane

As noted above, Catalysts A and B have comparable channel dimensions and geometric surface areas, but differ somewhat in channel shape. To evaluate the effects of this difference, small modules of each catalyst, consisting of honeycomb sections about 1 cm in diameter and 30 cm in length, are used.

In order to isolate the effects of channel shape on these reactions, a single channel on the top and bottom of each module is isolated by plugging all adjacent channel openings with cement. A stainless steel tube of ⅛″ O.D. is then adhesively mounted on the top of the isolated channel.

Each module is next loaded inside a tube reactor with the surrounding void space being filled by inert SiC particles, and the catalyzed channel walls of each module are pre-reduced in situ by flowing hydrogen gas at a pressure of 220 psig and a temperature of 400° C. through the channel for 10 hours.

Following catalyst pre-reduction, a feed stream consisting of hydrogen gas and liquid reactants is pre-heated to a predetermined reaction temperature and is then delivered downwardly into each single catalyst channel via the ⅛″ tube. The liquid reactant is made up of 0.5% 1-octene, 0.5 wt. % styrene, and 99% toluene.

Following processing through the honeycomb catalysts, the effluent from each catalyst module is cooled to a suitable separation temperature and the off gas and liquid product stream are separated. The liquid product is then analyzed to determine hydrogenation conversion of styrene to ethylbenzene, and 1-octene to n-octane, respectively.

This testing procedure is repeated at a number of different feed stream flow rates, but with all runs being carried out at a constant reactor pressure of 220 psig, a constant catalyst bed temperature of about 61° C., and a constant feed H2/oil volume ratio of 50Nl/l (50 liters H2 at standard temperature and pressure per liter of liquid). For each set of reaction conditions, the hydrogenation activity a of the catalyst is calculated from the following equations:

α=−LHSV·Ln(1−x)

LHSV=FV_{F}/V_{cat}

wherein LHSV is liquid-hourly space velocity; x is the olefin conversion fraction, FV_{F} is liquid feed volume flow rate, and V_{cat} is catalyst channel volume. The superficial liquid linear velocity is calculated by dividing the liquid feed rate by the cross-sectional area of the representative channel.

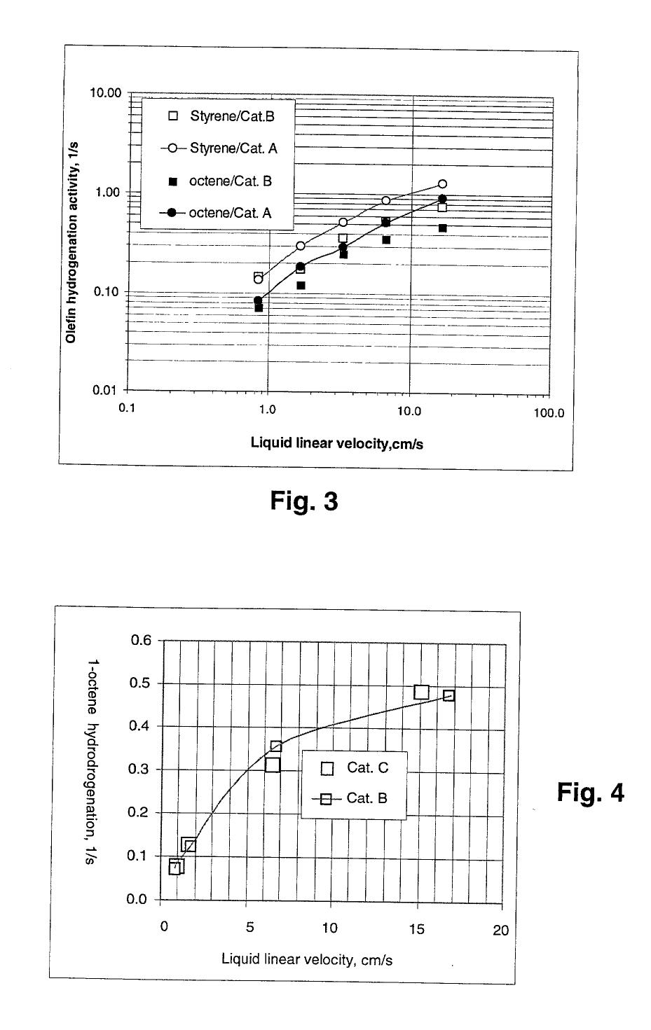

Referring to FIG. 3, variations in hydrogenation activity over a range of superficial liquid linear velocity is shown for each of Catalyst A (having a rounded corner channel shape) and Catalyst B (having a square channel shape). From the data in FIG. 3 it can be seen that both styrene hydrogenation activity and octene hydrogenation activity are higher with the catalyst channel of rounded corners (Catalyst A) that with the catalyst channel of square shape (Catalyst B), this performance advantage extending over the entire range of liquid linear velocities tested. This result is obtained despite the higher catalyst loading of Catalyst B (bulk catalyst), and its higher active (BET) surface area and pore volume.

The fact that channel shape has a greater effect on catalytic activity for some gas/liquid reactions than catalyst loading is reflected by the following example.

### EXAMPLE III

### Differing Wall Thicknesses

The testing procedure of Example II above is repeated for two honeycomb catalysts of square channel shape, i.e. Catalysts B and C from Table 1 above. For these tests, hydrogenation activity is measured for olefin (1-octene) conversion.

Both honeycomb catalysts are prepared using the same catalyst material and honeycomb extrusion process, and the catalysts are provided with comparable channel shapes, interior dimensions, and geometrical surface areas, but the wall thicknesses of the two catalysts differ substantially. Instead of the 0.18 mm wall thickness of Catalyst B, Catalyst C is provided with walls of 0.71 mm thickness.

For the purpose of these tests, single channels are isolated and evaluated for activity utilizing the same liquid feed as employed in Example II, and the tests are carried out over a similarly wide range of liquid linear velocities. The results of this testing are plotted in FIG. 4 of the drawings.

Referring specifically to FIG. 4, Catalyst C shows an activity for 1-octene hydrogenation that is quite similar to that of Catalyst B, even though the wall thickness of Catalyst C is nearly four times that of Catalyst B. This result suggests that, for this particular reaction, catalyst wall thickness is a much less significant factor than channel shape.

### EXAMPLE IV

### Circular Channel Catalyst Performance

Hydrogenation activity tests using the procedure described in Example II above are carried out to evaluate the comparative catalytic activities of Catalysts D and E for olefin hydrogenation. These two catalysts have similar compositions, cell densities and geometric surface areas, thus differing from each other principally in that Catalyst D has a square channel shape while Catalyst E has a circular channel shape.

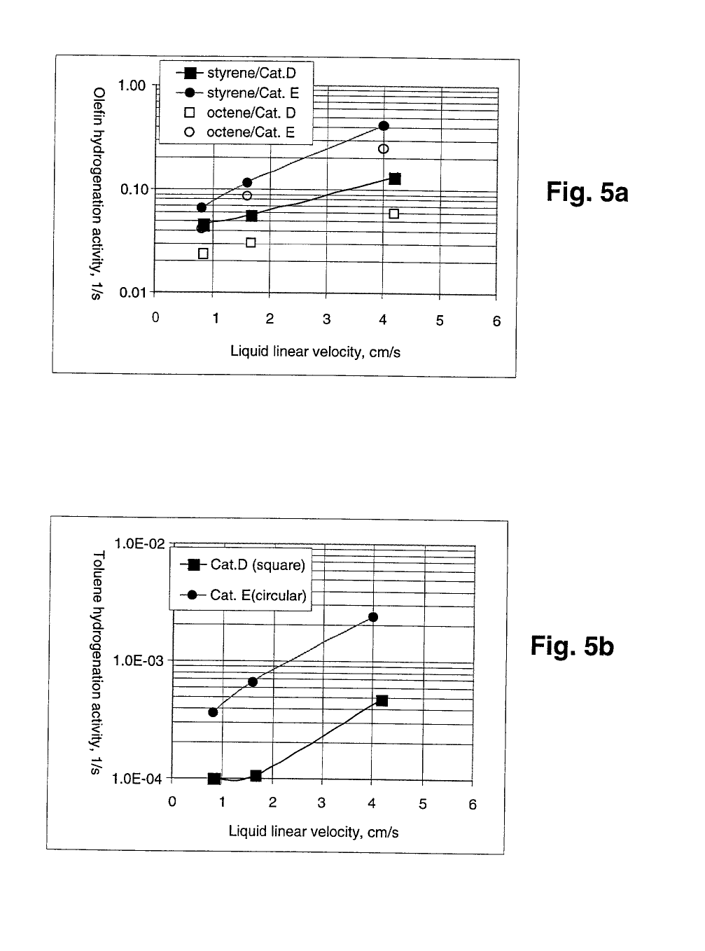

The results of olefin hydrogenation tests are shown in the graphs presented in FIGS. 5a-5b of the drawings. Referring specifically to FIG. 5a, the effects of channel shape on hydrogenation activity are shown over a range of liquid linear velocities at a constant reaction temperature of 61° C. and reaction pressure of 220 psig, with the feed H2/oil volume ratio being maintained at 50 Nl/l. Under those conditions, olefin hydrogenation activity over the catalyst of circular channel (Catalyst E) for both styrene and 1-octene is found to be consistently higher than that of the square channel (Catalyst D), typically by from 50 to 100%.

Particularly surprising is the fact that the activity advantage of circular channel shapes over square shapes is found to be even more significant for toluene saturation than for olefin hydrogenation. The saturation of toluene by hydrogenation proceeds in accordance with the following reaction:

toluene+H2→methyl cyclohexane

As shown in FIG. 5b of the drawings, catalytic activity for toluene saturation in the round channel catalyst is found to be from two to five times that of the square channel catalyst, with this advantage being observed over the entire liquid linear velocity range from about 0.8 to about 4.2 cm/s.

These results are particularly unexpected for a reaction that, under the reaction conditions employed, is kinetically much slower than the olefin hydrogenation reactions tested. Thus circular channels appear to enhance catalytic activity for chemical reactions over a range of kinetics, both fast and slow. Channel shape may affect not only catalytic activity, but under certain reaction conditions also the relationship of conversion or activity.

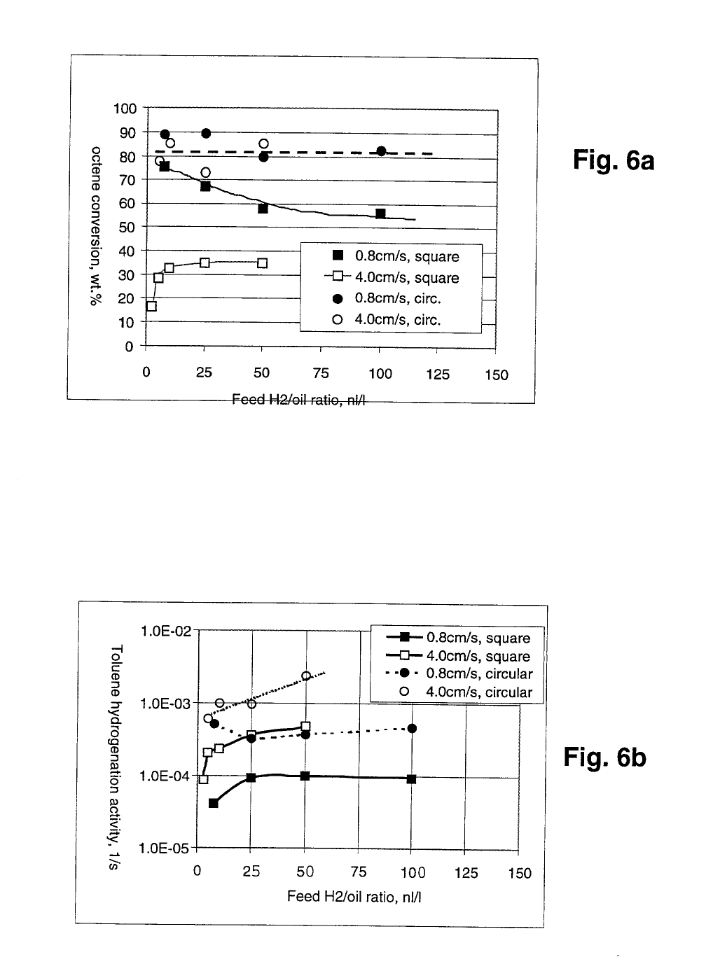

Additional tests to determine the effects of H2/oil ratio on catalytic activity are also conducted on Catalyst D and E, with the test setup described in Example II being used for that purpose. Some of the results of these tests are shown in the graphs presented in FIG. 6 of the drawings.

Referring specifically to FIG. 6 it can be seen that, for olefin hydrogenation, the octene conversions over square channel Catalyst D increase with the feed H2/oil ratio at high liquid linear velocity (VL=4.0 cm/s), but decrease with increasing feed H2/oil ratio at low liquid linear velocity (VL=0.8 cm/s). On the other hand, the octene conversion activity over circular channel Catalyst E is found to be insensitive to the feed H2/oil ratio at either liquid linear velocity.

For toluene saturation, catalytic activity generally increases with feed H2/oil ratio at both liquid linear velocities in square channel Catalyst D. A trend similar to that with the square channel catalyst is observed at VL=4.0 cm/s with the circular channel catalyst, but the variation of activity with feed H2/oil ratio at the higher liquid velocity of VL=0.8 cm/s is found to be very different. This result suggests that channel shape has effects on the dynamic behavior of the gas/liquid/catalyst surface reaction process which are beyond those relating to static effects.

### EXAMPLE V

### Toluene Hydrogenation Activity

Catalysts D and E are further evaluated as to catalytic activity for the hydrogenation of toluene to methyl cyclohexane at high temperatures. The testing procedure described in Example II is repeated, but using a liquid feed of 4.5 wt. % toluene in methylcyclohexane, maintaining a constant feed H2/oil volume ratio of 50 Nl/l, a constant reaction pressure of 220 psig, and a constant liquid linear velocity of 0.8 cm/sec.

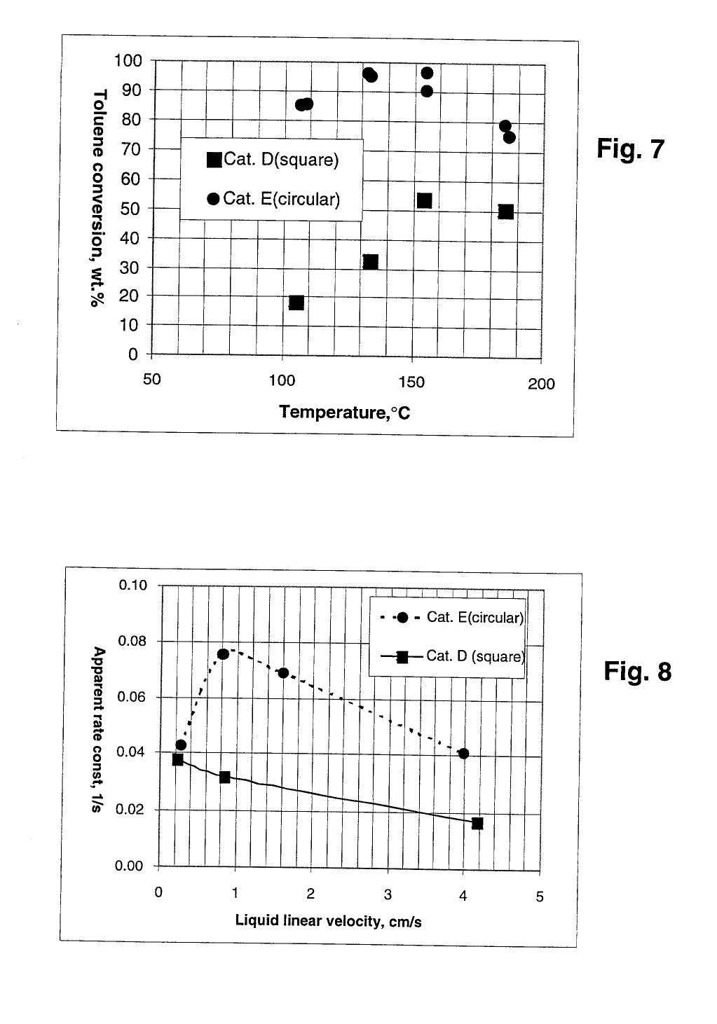

The results of this testing are shown in the graph illustrated in FIG. 7 of the drawing. As is evident from a study of FIG. 7, toluene hydrogenation over circular channel Catalyst E is significantly higher than that over square channel Catalyst D at all elevated reaction temperatures tested. Thus the advantage of the circular channel catalyst design for high toluene conversions at these liquid velocities is apparent.

The effects of varying liquid linear velocity on catalytic activity for this reaction are illustrated in the graph presented in FIG. 8 of the drawing. The data plotted in FIG. 8 are for a constant feed H2/oil ratio of 50Nl/l, a constant reaction temperature of 150° C., and a constant reaction pressure of 220 psig.

As the data in FIG. 8 indicate, the small activity advantage of circular channel Catalyst E becomes much greater as the superficial liquid linear velocity of the feed stream increases above 0.2 cm/sec. More significantly, the different trends in the data for each of the two channel shapes suggests the fundamental difference in hydrodynamic behavior resulting from the differences in channel shape.

Toluene conversion efficiency in circular channel Catalyst E is not dependent on reaction pressure, especially at higher pressures than those reported above. Thus FIG. 10 of the drawing, for example, shows efficiencies for toluene conversion at reaction pressures of about 100 psig, 220 psig, and 450 psig for that Catalyst, when the reaction temperature is maintained at 110° C., the superficial liquid velocity at 4 cm/sec, and the feed H2/oil ratio at 50Nl/l.

### EXAMPLE VI

### Crushed Catalyst Measurements

The relative activities of granular catalyst samples taken from the honeycombs of Catalysts D and E are compared, both to evaluate the general effects of the loss of honeycomb shape on apparent activity, and to measure any small differences in inherent activity arising from the need to use slightly different manufacturing techniques to shape the two catalysts.

Material from each of these two catalysts is crushed and sieved to produce coarse powder of 80 to 200 mesh particle size. The resulting powders, each of 140 mm average particle size, are calcined in an oven at 400° C. for 1 hour to remove residual hydrocarbons, and a 1.5 cc sample of each catalyst is then mixed with 30 cc of 60 mesh SiC particles and loaded into a tube reactor of 2 cm internal diameter suspended between end plugs of uncatalyzed 60 mesh SiC particles. Each catalyst sample is then pre-reduced with flowing H2 at 220 psig and 400° C. for 10 hours.

A mixed hydrogen/liquid feed is then introduced into the top of each tube reactor in a co-current downflow trickle mode. The liquid feed consists of 4.5 wt. % toluene in methylcyclohexane. Toluene conversion in each reactor is then measured at two different reaction temperatures keeping the feed stream H2/oil ratio constant at 50Nl/l, the liquid hourly space velocity (LHSV) of the feed stream constant at 93 l/h, and the reaction pressure constant at 220 psig.

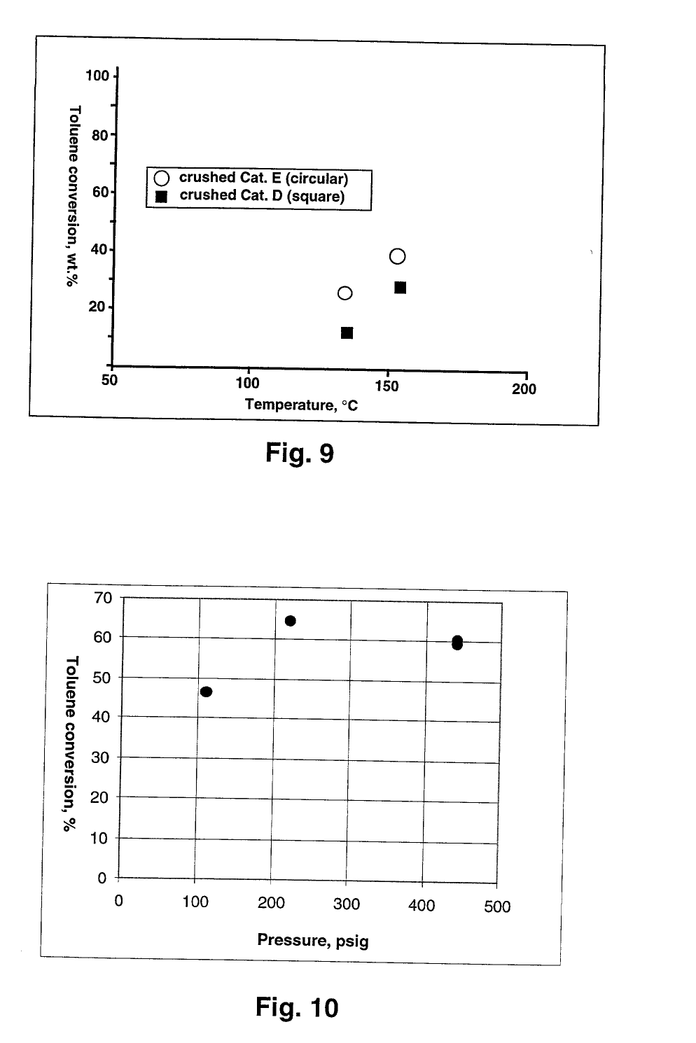

The toluene conversion efficiencies for the two thus-prepared granular catalyst samples tested as described above are reported in FIG. 9 of the drawings. The granular sample of Catalyst E shows a slightly higher inherent conversion efficiency that Catalyst D and, as shown above in Example V and FIG. 7, this small difference is significantly enlarged when the catalysts are tested under substantially the same conditions in the form of honeycomb monoliths of two different channel shapes. Equally evident are the much higher conversion efficiencies shown by the honeycomb monoliths than by the same catalysts when distributed in conventional trickle bed reactor configurations.

As previously noted, the shape factors contributing to the efficiency of rounded channel shapes to support gas-liquid catalytic reactions in honeycomb monoliths have been found to enhance their efficiency for gas-liquid mass transfer applications as well. Thus any of the rounded-channel honeycomb support structures disclosed in the foregoing examples may be used without the addition of catalysts as packing structures, serving as high-efficiency gas-liquid contactors in processes wherein the rapid mass transfer between gas and liquid feedstream components is required or beneficial. Examples of processes that will benefit from such use include absorption, scrubbing, stripping and distillation processes.

In one series of tests wherein the stripping of oxygen from liquid phase water by nitrogen passing through structured honeycomb supports was evaluated, gas-liquid mass-transfer coefficients in the range of 0.027-0.035 per second over a superficial liquid linear velocity range of 0.024-0.040 m/s were measured for a rounded channel honeycomb having a geometric surface area (GSA) of about 550 m2/m3 and a channel hydraulic diameter of 4.31 mm. This represented a nearly 3×improvement from the mass-transfer values of about 0.010-0.013 measured for a square-celled honeycomb of GSA 660 m2/m3 and channel hydraulic diameter 4.11 mm over the same range of superficial liquid velocities.

From the foregoing description it will be apparent that other modifications and changes varied to fit particular operating requirements and environments may be resorted to by those skilled in the art in the practice of the invention as hereinabove described. Thus the invention is not considered limited to the particular examples chosen above for purposes of illustration, but rather covers all changes and modifications which do not constitute departures from the true spirit and scope of the invention as defined by the appended claims.

We claim:

1. A structured catalyst comprising channels of a geometry comprising inner walls whose cross-sectional surfaces are substantially free of acute and sharply obtuse interior corner angles, the catalyst being used for liquid/catalyst and gas/liquid/catalyst contacting and reaction.

2. The structured catalyst in accordance with claim 1, wherein said channels form at least a part of a honeycomb monolith catalyst structure.

3. The structured catalyst in accordance with claim 1, wherein said inner walls of said channels support a solid catalyst.

4. The structured catalyst in accordance with claim 3, wherein said solid catalyst is disposed upon or within said inner walls of said channels.

5. The structured catalyst in accordance with claim 1 wherein said channels have an average cross-sectional diameter in the range of about 0.1 to 10 mm.

6. The structured catalyst in accordance with claim 1 wherein said inner walls of said channels are substantially free of corners.

7. The structured catalyst in accordance with claim 1 wherein said inner walls of said channels have corner radii of above approximately ten percent of their channel diameter.

8. The structured catalyst in accordance with claim 1 wherein said inner walls of said channels define an approximately circular cross-section.

9. A structured catalyst of honeycomb configuration comprising a plurality of parallel channels bounded by catalytically active walls traversing the catalyst from an inlet end to an outlet end thereof, wherein the cross-sectional shape of the channels is free of angled corners and free of curvatures having curvature radii below 10% of the average channel diameter.

10. A method for carrying out a liquid/solid or gas/liquid/solid reaction comprising the step of conveying a liquid or gas/liquid feedstream through a solid catalyst of honeycomb configuration comprising a plurality of parallel channels bounded by catalytically active walls traversing the catalyst from an inlet end to an outlet end thereof, wherein the cross-sectional shape of the channels is free of angled corners and free of curvatures having curvature radii below 10% of the average channel diameter.

11. The method in accordance with claim 10 wherein said reaction comprises a liquid/catalyst contacting and reaction.

12. The method in accordance with claim 10 wherein said reaction comprises a gas/liquid/catalyst reaction.

13. The method in accordance with claim 10 wherein said channels are utilized for conducting gas/liquid/catalyst hydrotreating reactions.

14. The method in accordance with claim 10 wherein said channels are utilized for conducting gas/liquid/catalyst hydrogenation reactions.

15. The method in accordance with claim 10 wherein said reaction is conducted under conditions of liquid linear velocity of between approximately 0.01 and 100 cm/s.

16. The method in accordance with claim 12 wherein said reaction is conducted under conditions wherein said feed has a gas/liquid volume ratio of between approximately 0 and 1000.

17. A method for carrying out a hydrotreating reaction comprising the step of conveying a gas/liquid feedstream through a solid catalyst of honeycomb configuration comprising a plurality of parallel channels bounded by catalytically active walls traversing the catalyst from an inlet end to an outlet end thereof, wherein the cross-sectional shape of the channels is free of angled corners and free of curvatures having curvature radii below 10% of the average channel diameter.

18. A method for carrying out a gas-liquid mass-transfer process comprising the step of conveying gas and liquid feedstreams through a packing structure of honeycomb configuration comprising a plurality of parallel channels bounded by channel walls traversing the structure from an inlet end to an outlet end thereof, wherein the cross-sectional shape of the channels is free of angled corners and free of curvatures having curvature radii below 10% of the average channel diameter.

19. A method in accordance with claim 18 wherein the gas-liquid mass transfer process is an absorption, scrubbing, stripping or distillation process.
